(19) United States
(12) Patent Application Publication
(10) Pub. No.: US 2024/0390232 A1
(43) Pub. Date: Nov. 28, 2024

(54) Baby Bottle Holder

(71) Applicant: MELVIN PUTHENPURAYIL MATHEW, Richmond, TX (US)

(72) Inventor: MELVIN PUTHENPURAYIL MATHEW, Richmond, TX (US)

(21) Appl. No.: 18/201,774

(22) Filed: May 25, 2023

(51) Int. Cl. A61J 9/06

(52) U.S. Cl. CPC A61J 9/0623; A61J 9/0692

(57) ABSTRACT

The present invention discloses a baby bottle holder which includes a strap and fastener by which the wrist of the user can be fastened while the other end is a string like structure to hold bottle having a free or unrestricted cross-sectional area of suitable dimensions. The assembly base which is compact and lock more securely to the hand and also provides cushion for the wrist. This invention thus acts to restrain the bottle holding utilizing both hands. The user can fix the holder with one hand and can utilize the other hand in other daily chores. This device can be used by anyone with any skill level and does not need a learning curve. This device can be used as a mobile device holder, cup holder and for baby bottle holder.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention relates to baby bottle holders and feeders and more particularly pertains to a baby bottle holder and feeder which may be employed to hold a baby bottle using single hand where the weight of bottle will be evenly distributed along the hand and wrist.

### Description of the Related Art

A baby bottle is a small bottle used to feed a baby or an infant that includes a nipple that encloses the top thereof and provides a means for the baby to obtain the liquid inside the bottle. The baby bottle is used as a substitute for breastfeeding and normally contains an infant formula or expressed breast milk. Baby bottles vary in size where larger bottles typically hold 270 milliliters or smaller bottles that hold approximately 150 milliliters. An infant usually is unable to hold a bottle and therefore while feeding an adult or guardian needs to hold the bottle while the baby sucks on the nipple to drink the formula. As a baby gets older and grows in size the baby may be able to hold the bottle but many times the infant will drop the bottle during the feeding process.

Devices for holding baby bottles are well known to those skilled in the art. These devices are often used to hold the nursing bottle during the feeding of an infant. This invention relates to improvements in baby bottle holders as compared to the present art. It is well known fact that when feeding babies mother can experience difficulty in feeding the baby due to the fact that the bottle will roll down among the bed clothes and this makes it necessary for the attendant to retrieve the bottle and to again put it in possession of the baby. It is often necessary for the attendant to hold the bottle continuously, while the baby is feeding. This is the baby go to sleep as it invariably wakes up when it loses the bottle. There are multiple inventions that have been found in prior art in this regard.

For instance, Baby bottle holder and feeder bearing U.S. Pat. No. 5,489,075A is issued to Ible; Robert L. The patent discloses a baby bottle holder and feeder including a lightweight, hollow articulating arm having a clamp member affixed at one end for the purpose of holding a baby bottle for feeding and having another clamp member affixed at the opposite end for the purpose of clamping the baby bottle holder and feeder to a nearby object such as a baby's car seat. The articulating arm is generally of plastic composition and permits movement by a child as required to initiate, perform, and terminate self-feeding. The clamp member holding the baby bottle is spring actuated and having pads between planar extensions of the jaws of the clamp member for softening impact there between subsequent to removal of the bottle should an older child desire such release.

Another patent on Baby bottle holder bearing U.S. Pat. No. 5,135,189A is issued to Mansoor Ghazizadeh. The patent discloses an apparatus for holding a baby bottle is disclosed. This device contains means for gripping the bottle and a flexible arm. The gripping means contains a base and, integrally formed therewith, at least two fingers extending from the base. Each of the fingers contains a top portion which extends divergingly away from the top portions of each of the other fingers.

A U.S. Pat. No. 4,989,811A is a Attachable baby bottle holder with an attaching mechanism is issued to Millis Patricia C, Millis Iii H Lowell. The patent discloses a baby bottle holder according to the present invention is composed of a sleeve of foam rubber material having a circular bottom piece of the same material which together form a cylindrical jacket for holding the bottle. In addition, one end of an elastic strap is attached to the sleeve near its top while a hoop and hook fastener arrangement is attached to the other end of the strap. The jacket and bottle may be thus secured to any suitable nearby object having an unobstructed or free cross-sectional area by the strap and fastener. The jacket thus serves to both thermally insulate and protect the bottle while the strap restricts the movement of the jacket and bottle whenever it is released by the baby using it thereby greatly simplifying the bottle's retrieval.

A U.S. Pat. No. 6,158,870A is issued to Ramirez; John A discloses a combination of musical and lightable baby bottle. The patent depicts a nursing baby bottle attachment with (an) entertainment device(s) associated therewith, especially the options of both, or either, chosen jingles of music and randomly flashing lights. Such may be just the music, [symbol] the paired music and lights with a micro-switch to turn off the lights alone.

A U.S. Pat. No. 5,489,075A on Baby bottle holder and feeder is issued to Robert L. Ible. The patent is on a baby bottle holder and feeder including a lightweight, hollow articulating arm having a clamp member affixed at one end for the purpose of holding a baby bottle for feeding and having another clamp member affixed at the opposite end for the purpose of clamping the baby bottle holder and feeder to a nearby object such as a baby's car seat. The articulating arm is generally of plastic composition and permits movement by a child as required to initiate, perform, and terminate self feeding. The clamp member holding the baby bottle is spring actuated and having pads between planar extensions of the jaws of the clamp member for softening impact therebetween subsequent to removal of the bottle should an older child desire such release.

Another patent on Baby bottle holder bearing U.S. patent 2,008,0093513A1 is issued to Vicki Kunzelman. The patent is [symbol] a method and apparatus configured to promote or encourage baby self-feeding. A baby bottle holder including a body defining an area to encourage the hands or arms of the baby to access the bottle. A baby bottle holder including hypoallergenic filler.

A U.S. Pat. No. 6,003,821A on Decorative holder for a baby bottle is issued to Bob Fabian Danny Manthis. The patent is on a decorative holder for a baby bottle includes a flexible arm having a bottle receiver at one end and a clamp at the opposite end. A decorative cover in the form of an animal is removably wrapped around the flexible arm, with the animal's head near the bottle receiver and the animal's groin near the clamp. A baby bottle is placed in the bottle receiver, the clamp is attached to a support structure such as a crib, and the flexible arm is positioned so the baby can feed.

Baby bottle holder bearing U.S. Pat. No. 5,873,551A is issued to Jones; Philip J. The patent discloses a baby bottle holder provides for the hands free holding of a baby bottle for bottle feeding an infant, thus enabling the person caring for the infant to have both hands free for holding the infant and/or performing other duties as required. The holder comprises several embodiment's, each of which has a neck sling removably securable about the neck of the user and a bottle securing strap which secures removably about the neck of the baby bottle adjacent the nipple end of the bottle. Some embodiment's comprise a pliable sleeve having a conical section with all diameters greater than that of the bottle, with the bottle being placed in the sleeve with the nipple end toward the larger diameter portion of the sleeve. The nipple of the bottle thus extends downward for feeding the infant, with the bottle being secured by the bottle securing strap. The bottle is easily tilted upwardly to preclude leakage from the nipple when not in use, by everting the sleeve over the upper end of the bottle. Other embodiment's utilize an elastic strap for the sleeve portion, with a pliable connecting sheet or strap between the sleeve and the bottle securing strap. The bottle may be positioned with the nipple upward by sliding the elastic sleeve toward the nipple end of the bottle, thus positioning the center of gravity of the bottle beyond the sleeve. Each embodiment allows the user to position the bottle easily either nipple downward or nipple upward, as desired.

A Baby bottle holder bearing U.S. Pat. No. 5,192,041A is issued to Bryant Sheree M. The patent discloses a device for supporting an infant's feeding bottle including a bottle holder, a first flexible rod optionally, a second flexible rod, a clamp member and a stand member. The feeding bottle may be selected from a plurality of feeding bottles having a range of different diameters. The device may be used while feeding an infant in a seat placed on a surface. The bottle holder has a flexible member [symbol] wrapping around the feeding bottle. The flexible member has VELCRO material, a buckle or the like for securing the feeding bottle to the bottle holder. The first flexible rod is attached to the bottle holder and the stand member. The second flexible rod may be pivotally attached to the first flexible rod. The clamp member is attached to the second flexible rod for clamping to the seat.

The baby bottle holders of the prior art have limitations with respect to the positions of use. As noted, many holders attach to a baby seat or may be integrated with the infant's seat. Other holders although more flexible are still geared toward attachment near the seat of the infant and may not have the flexibility to use other circumstances. It is evident that a lot of labor and inconvenience would be obviated if some satisfactory means could be employed for holding the bottle in the proper position while the baby is feeding.

The current invention proposes to provide a bottle holder which facilitate the user to hold bottle with single hand comfortably. The users can lock the device to their hand using the thumb finger lock and the velcro locking mechanism. The new base, which is more compact will lock the assembly securely to the hand and provides cushion inside for the wrist. The bottle can be placed in the circular lock mechanism which is a universal fit for every type of bottle. The material is flexible and is proposed to retain its shape as per the user's adjustment.

None of the previous inventions and patents, taken either singly or in combination, is seen to describe the instant invention as claimed. Hence, the inventor of the present invention proposes to resolve and [symbol] existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of bottle holding assembly.

The primary objective of this invention is to provide a way to bottle-feed and hold the baby using just one hand and the compact base design, will lock more securely to the hand, and provides cushion inside for the wrist.

It is another objective of the invention to provide material which can easily adjust and retain its shape as per variable bottle or wrist size.

It is further the objective of the invention to provide [symbol] apparatus which can be used as a mobile device holder, bottle holder and cup holder.

It is also the objective of the invention to provide a holding assembly which is easy to use.

It is another objective of the invention to provide an assembly which is highly portable.

A still further object is to provide a bottle holder that is economical in cost to manufacture.

It is a further object of the present invention to provide a new and improved form of bottle holder which is of a durable and reliable construction.

Still yet another object of the present invention is to provide a new and improved bottle holder which provides in the apparatuses and methods of the prior art some of the advantages thereof, while simultaneously overcoming some of the disadvantages normally associated therewith.

The invention has a further object to provide user with aesthetic satisfaction by showcasing a beautiful and smart design of baby bottle holder.

This Summary is provided merely for purposes of summarizing some example embodiment's, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

FIG. 1 is a view of baby bottle holder as described in the present invention;

FIG. 2 is another view of baby bottle holder as described in the present invention;

FIG. 3 is a perspective view of conventional appearance embodying the present invention;

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The current invention proposes to provide a bottle holding assembly which allows the user to hold the bottle using single hand. The invention as per its preferred embodiment is a bottle holding assembly which allows the user to feed the baby using single hand. The assembly allows the user to just use one hand comfortably and perform other task using the other hand.

The assembly is designed in such a way that the device can be easily worn on the wrist of user. The assembly is highly flexible and hence can be used at any angle and with minimal effort required to correct the baby head to the angle of the bottle which is a common problem parent usually face.

The assembly is designed in such a way that it evenly distributes wait of bottle along the wrist and arm and thus avoids the user's arm to get tired after feeding for long period of time.

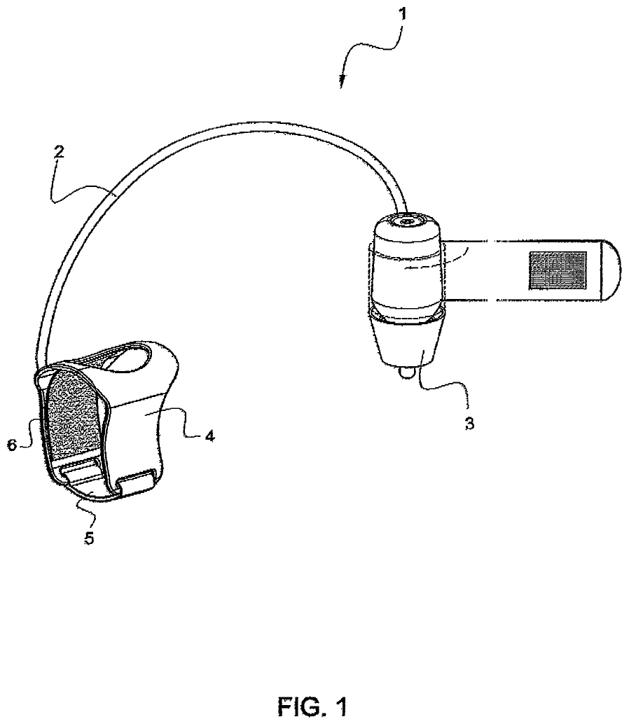

Here presenting how the assembly can be used ideally, for instance, a mother feeding baby holding baby in her lap and feeding her through the bottle. The mother will use the baby bottle holder device as shown in FIG. 1 & 2. The user can lock the device to their hand using the thumb finger lock and the Velcro locking mechanism. The bottle will be securely placed in the circular lock mechanism.

This device can be used by anyone with any skill level and does not need a learning curve. This device can be used as a mobile device holder, cup holder depending on the person using it. The main use of this device will, however, be to hold baby bottles.

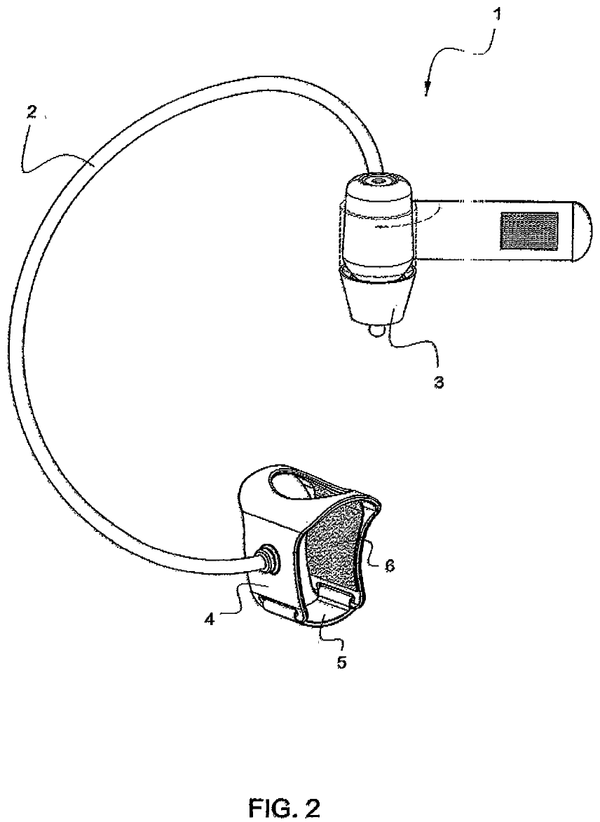

Now to explain the invention further, we will explain further all images over here. The FIG. 1 and FIG. 2 shows the baby bottle holder as per preferred embodiment of the invention in multiple views. The apparatus for holding a baby bottle comprised of means for gripping said bottle (3), a flexible arm holding mechanism where the users can lock the device to their hand using the thumb finger lock (5) and the velcro locking mechanism (6,7). The first end and a second end, means are connected (2) through a flexible and elastic material which allow the assembly to remain in consistent shape and size.

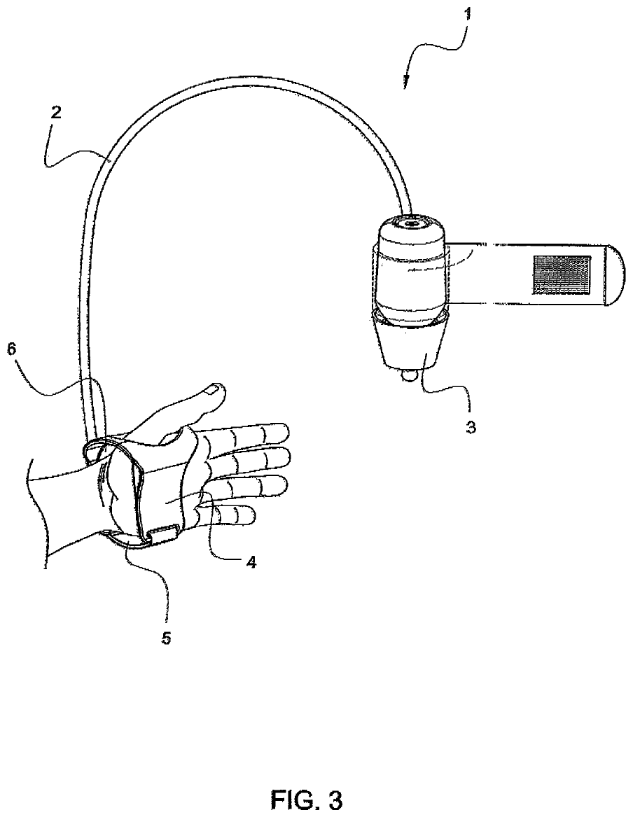

Furthermore, the FIG. 3 shows the baby bottle holder in multiple views. 1 of the images show the holder in its closed form. The other image shows the Velcro locking mechanism. While the other 2 images show the baby bottle holder where the user is wearing the bottle holder. As per preferred embodiment of the invention, a flexible arm holding mechanism where the users can lock the device to their hand using the thumb finger lock (5) and the velcro locking mechanism (6,7). The first end and a second end, means are connected (2) through a flexible and elastic material which allow the assembly to remain in consistent shape and size.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiment's of the present invention.

The apparatus and method components have been represented where appropriate by conventional symbols in the drawings, showing only those specific details that are pertinent to understanding the embodiment's of the present invention so as not to obscure the disclosure with details that will be readily apparent to those of ordinary skill in the art having the benefit of the description herein.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiment's for the purpose of streamlining the disclosure. This method of disclosure is not to be interpreted as reflecting an intention that the claimed embodiment's require more features than are expressly recited in each claim. Rather, as the following claims reflect, inventive subject matter lies in less than all features of a single disclosed embodiment. Thus, the following claims are hereby incorporated into the Detailed Description [symbol] with each claim standing on its own as a separately claimed subject matter

[symbol]

1. A baby bottle holder and feeder for the purpose of holding a baby comprising:
a first clamp member engaging a baby bottle wherein said first clamp member comprises a string like structure;
wherein the said portion has a mouth adapted to receive a baby bottle;
the string like structure can grasp the bottle tightly within;
the second clamp member engages the hand and wrist of the user;
a locking mechanism where user can lock the device to their hand using the thumb finger lock;
a velcro locking mechanism to be engaged on user's wrist for tight and reliable grip;
wherein said flexible arm is fully extended to its maximum length, the distance between said means for gripping said bottle and said clamp is less than about 1.5 feet;
wherein said apparatus weighs less than about 1 pound.
